(19) United States
(12) Patent Application Publication
(10) Pub. No.: US 2019/0003725 A1
(43) Pub. Date: Jan. 3, 2019

(54) HOT WATER CONTROLLER

(71) Applicant: SHARP ENERGY INVESTMENTS PTY LTD, Cedar Creek, Queensland (AU)

(72) Inventors: Geoff HOURIGAN, Cedar Creek, Queensland (AU); Troy NORRIS, Cedar Creek, Queensland (AU)

(21) Appl. No.: 16/062,081

(22) PCT Filed: Nov. 15, 2016
(86) PCT No.: PCT/AU2016/051094

§ 371 Date: Jun. 13, 2018

(30) Foreign Application Priority Data
Dec. 14, 2015 (AU) 2015905163

(51) Int. Cl. F24D 19/10; F24H 9/20; G05F 1/67; H02M 1/10

(52) U.S. Cl. CPC F24D 19/1063; F24H 9/2021; G05F 1/67; H02M 1/10; H02J 3/383; F24D 2200/08; F24H 2240/09; F24H 2250/02; F24D 2200/02

(57) ABSTRACT

This invention relates in general to a renewable energy water heating system and method for residential and commercial applications. The heating system has a renewable energy source providing a DC electric current and a controller connected to the renewable energy source. The water heater is connected to the controller, the water heater having a water storage tank and at least one heating element for heating water in the tank responsive to an electric current supplied thereto. The controller modulates and switches the DC electric current to produce a converted output to provide the electric current to the at least one heating element to heat the water.

### FIELD OF THE INVENTION

This invention relates to a renewable energy water heating system and method for residential and commercial applications.

### BACKGROUND OF THE INVENTION

It should be noted that reference to the prior art herein is not to be taken as an acknowledgement that such prior art constitutes common general knowledge in the art.

In household and commercial usage, most water heating systems are of a storage type unit and are used to provide heated potable water to various hot water-utilising plumbing fixtures such as sinks, showers, dishwashers and the like. Such storage type water heaters typically include a cylindrical vessel/container (i.e., tank) in which water is kept continuously hot and ready for use. Heating the water in the tank is typically affected by way of electrical heating elements. The electrical element within the tank is selectively operated to heat the water within the tank to a preset temperature. Operation of the element is controlled by a thermostat that monitors/measures the temperature within the tank. When the water within the tank is below a desired temperature, the electrical element is energised to heat the tank and the water therein. Often, the source of the energy for heating is an electric power distribution company.

As the cost of the electricity continues to rise, a growing need has developed to reduce water heating costs in both residential and commercial applications. The use of energy collected from resources which are naturally replenished, such as sunlight, wind and rain are becoming more desirable. One such renewable energy system is the solar water heater which heats the water directly by exposure to solar radiation. Typically this is accomplished by pumping the water to be heated through solar collector panels. Such systems involve relatively complicated plumbing in relatively inconvenient locations, increasing initial cost and maintenance expense.

The photovoltaic array is also utilised for generating electrical power for a variety of purposes, including powering conventional appliances. This can include the electrical hot water system. However, the photovoltaic arrays produce direct current (DC) and these appliances are normally powered by alternating current (AC) power from the utility grid. Therefore the electrical hot water system will require the use of a complex power inverter to convert the DC voltage provided by the photovoltaic array to the AC voltage provided by the electric utility. Typically, an AC thermostat is designed for AC power, not DC hence the reason the DC must be inverted to AC. If an AC thermostat is used with a direct coupled DC supply, when the thermostat opens and closes at the set temperature, the DC will arc considerably and burn the contacts. In this situation, the thermostat will eventually cease to operate and won't last long as it is being operated outside its recommended rating.

Other systems have been developed in which photovoltaic modules generating direct current (DC) is coupled directly (no conversion to alternating current) to resistive heating elements and associated DC thermostat. The resistive heating element replaces the standard heating elements in a conventional, electric hot water system. Alternatively, if no DC thermostat is used a microprocessor controls a set of electrical relays that connect the photovoltaic module to the resistive heating elements in a manner that best matches the instantaneous operating characteristics of the photovoltaic modules.

Clearly it would be advantageous if a renewable energy water heating system and method for residential and commercial applications could be devised that helped to at least ameliorate some of the shortcomings described above. In particular, it would be beneficial to provide a renewable energy water heating system which is adapted to be easily implemented without the need for any significant changes to the electric hot water system.

### SUMMARY OF THE INVENTION

In accordance with a first aspect, the present invention provides a renewable energy hot water heating system comprising: a renewable energy source providing a DC electric current; a controller connected to the renewable energy source; an electric water heater connected to the controller, the water heater comprising a water storage tank and at least one AC heating element and at least one AC thermostat for heating water in the tank responsive to an electric current supplied thereto; and wherein the controller comprises a pair of pulse width modulated insulated-gate bipolar transistors which modulate and switch the DC electric current from the renewable energy source to produce a pulsed DC output to the at least one AC heating element and AC thermostat to heat the water.

Preferably, the renewable energy source may be any one or more of solar, wind or hydro energy.

Preferably, the controller may further comprise a microcontroller, the microcontroller produces a pulse width modulated signal to switch the DC electric current from the renewable energy source to switch the pair of insulated-gate bipolar transistors to produce the pulsed DC output to provide the electric current to the at least one AC heating element and thermostat.

Preferably, the pair of insulated-gate bipolar transistors may be connected in parallel and the microcontroller is adapted to switch in a parallel mode or single-ended mode to switch the pair of parallel connected insulated-gate bipolar transistors at the same time to provide the pulsed DC output to the at least one AC heating element and thermostat. The controller may further comprise surge and reverse polarity protection devices. The controller may further comprise an arc fault detection circuit adapted to suppress any arching within the AC thermostat caused by the pulsed DC output from the controller, the arc fault detection circuit is designed to quickly disconnect an output of the pair of insulated-gate bipolar transistors by shutting down the microcontroller. The controller may further comprise a microcontroller low drop out linear regulator.

Preferably, the efficiency of the hot water heating system may be achieved through the low energy consumption of the arch suppression, pulse width modulation and insulated-gate bipolar transistor switching. Preferably, the hot water heating system may be 97% efficient.

Preferably, the AC thermostat is located in series with the at least one AC heating element, and wherein the pulsed DC output is supplied to the AC heating element via the AC thermostat.

Alternatively, the electric water heater may comprise two AC heating elements for heating water in the tank, one AC element is provided with the pulsed DC electric output and a second AC element is provided with an AC grid connection to provide the electric current to the second AC heating element. The electric water heater may comprise an AC thermostat in series with each AC heating element.

In accordance with a further aspect, the present invention provides a renewable energy hot water heating system comprising: a renewable energy source providing a DC electric current; an AC electric current supplied by a grid connection; a controller connected to the renewable energy source and the grid connected AC, the controller comprises a pair of pulse width modulated insulated-gate bipolar transistors which modulate and switch the DC electric current from the renewable energy source to produce a pulsed DC converted output; an isolator switch for selecting either the renewable energy source or the AC grid connection; an electric water heater connected to the controller, the water heater comprising a water storage tank and at least one AC heating element and at least one AC thermostat for heating water in the tank responsive to an electric current supplied thereto; and wherein when the isolator switch is connected to the renewable energy source the controller provides the pulsed DC electric current to the at least one AC heating element and AC thermostat.

Preferably, the renewable energy source may be any one or more of solar, wind or hydro energy.

Preferably, the controller may comprise any one of the features of the controller described in the first aspect.

Preferably, when the renewable energy source is solar energy the hot water heating system of this and the first aspect may comprise: an array of photovoltaic panels connected to provide the DC electric current; and a DC isolator switch for disconnecting the output of the array of photovoltaic panels from the controller.

In accordance with a still further aspect, the present invention provides a method for heating water using a renewable energy source, the method comprising the steps of: (a) storing water in a storage tank, the tank comprising at least one AC heating element and at least one AC thermostat for heating water in the tank responsive to an electric current supplied thereto; (b) exposing the renewable energy source to its activating source to produce a DC electric current; (c) providing a controller with a pair of pulse width modulated insulated-gate bipolar transistors which modulate and switch the DC electric current from the renewable energy source to produce a pulsed DC converted output; and (d) providing the pulsed DC converted output of the controller to the at least one AC heating element and AC thermostat to heat the water in the storage tank.

Preferably, the method for heating water using a renewable energy source may further comprise any one of the features of the renewable energy hot water heating described in the previous aspects.

In accordance with a still further aspect, the present invention provides a solar hot water heating system comprising: an array of photovoltaic panels for producing direct current power; a water storage tank comprising a cold water inlet, a hot-water outlet, at least one AC heating element and an AC thermostat; and a controller connected between the array of photovoltaic panels and the AC heating element and the AC thermostat of the water storage tank; and wherein the controller comprises a pair of pulse width modulated insulated-gate bipolar transistors which modulate and switch the DC electric current from the array of photovoltaic panels to produce a pulsed DC converted output to the at least one AC heating element and AC thermostat to heat the water.

Preferably, the water storage tank may comprise two AC heating elements for heating water in the tank, one AC element is provided with the pulsed DC converted power and a second AC element is provided with an AC grid connection to provide the electric current to the second AC heating element.

Preferably, the water heating system may further comprise an alternating current power source connected to the controller and an isolator switch on the controller to enable the controller to be configured to alternatively connect the direct current power from the array of photovoltaic panels or the alternating current power from the alternating current power source to the at least one heating element.

Preferably, the controller may comprise any one of the features described in the first aspect.

In accordance with a still further aspect, the present invention provides a solar hot water heating system comprising: a storage tank having an inlet fluidly connectable to a water supply, an outlet fluidly connectable to at least at least one valve, wherein when the valve is opened, water from the water supply displaces water through the storage tank and out the outlet; a first AC heating element connectable to a power source that provides AC electricity; a first AC thermostat interconnected to the first AC heating element, wherein the thermostat controls operation of the first AC heating element based at least in part on a temperature of water in the storage tank; a controller connected to a power source that provides DC power, the controller comprises a pair of pulse width modulated insulated-gate bipolar transistors which modulate and switch the DC electric current from the DC power source to produce a pulsed DC converted output a second AC heating element connectable to the pulsed DC converted output of the controller; and a second AC thermostat interconnected to the second AC heating element, wherein the thermostat controls operation of the second AC heating element based at least in part on a temperature of water in the storage tank.

Preferably, the DC power source may be provided by any one or more of: (a) a solar power system; (b) a wind power system; (c) a hydroelectric power system; or (d) a battery. Preferably, the AC power source may be provided by any one or more of: (a) a grid connected transmission system; or (b) a generator. Preferably, the controller may further comprise any one of the features described in the first aspect. Preferably, the battery may be charged by any one of: (a) the solar power system; (b) the wind power system; (c) the hydroelectric power system; (d) the grid connected transmission system; or (e) the generator.

In accordance with a still further aspect, the present invention provides a renewable energy controller for providing a modulated and switched output to at least one appliance, the renewable energy controller comprising: a renewable energy source providing a DC electric current to an input of the controller; a buck voltage regulator; a microcontroller; at least one insulated-gate bipolar transistor and an associated driver circuit; and wherein the microcontroller produces a pulse width modulated signal to switch the DC electric current from the renewable energy source to switch the at least one insulated-gate bipolar transistor to produce the converted output to provide the electric current to the at least one appliance.

Preferably, the controller may comprise any one of the features described in the first aspect.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 illustrates a schematic drawing of hot water heating system in accordance with an embodiment of the present invention;

FIG. 2 shows the controller case of the hot water heating system of FIG. 1;

FIG. 3 shows a block diagram illustrating the components of the controller of FIG. 2;

FIG. 4 illustrates a schematic drawing of hot water heating system of FIG. 1 showing the connection to the utility grid;

FIG. 5 illustrates a schematic drawing of hot water heating system in accordance with a further embodiment of the present invention;

FIG. 6 shows the controller case of the hot water heating system of FIG. 5;

FIG. 7 shows a block diagram illustrating the components of the controller of FIG. 6;

FIG. 8 shows a schematic drawing of a hot water heating system in accordance with a further embodiment of the present invention; and

FIG. 9 shows a circuit diagram for the controller of FIG. 3.

### DETAILED DESCRIPTION OF THE INVENTION

The following description, given by way of example only, is described in order to provide a more precise understanding of the subject matter of a preferred embodiment or embodiments.

The present invention provides a renewable energy hot water heating system 10 which provides a very efficient system which is easily retrofitted to an existing electric hot water system 70 using the original AC heating element 72 and thermostat. The renewable energy source 50 provides a DC electric current to a controller 10. The water heater 70 is connected to the controller 10. The water heater 70 comprises a water storage tank and at least one heating element 72 for heating water in the tank responsive to the electric current supplied thereto. The controller 10 modulates and switches the DC electric current from the renewable energy source 50 to produce a converted output to provide the electric current to the at least one heating element 72 to heat the water.

The output from the controller 10 and the fast switched parallel single-ended connected IGBT's is akin to a fast pulsating direct current or a fast pulsed signal run on top (superimposed) of the DC signal. Pulsating direct current has an average value equal to a constant (DC) along with a time-dependent pulsating component added to it. In comparison the average value of alternating current is zero in steady state (or a constant if it has a DC offset, value of which will then be equal to that offset).

The output from the IGBT's and the controller 10 is a DC voltage that produces a direct current, it does not change in polarity. The pulsed DC output from the IGBT's is used to feed the AC thermostat and AC heating element 72. There is no requirement to replace the thermostat or the heating element 72 when utilising the present invention. It is particularly important to note that the AC thermostat and heating element 72 are fed with a continuous DC current and not the standard alternating current.

While the renewable energy source will be described and illustrated as a photovoltaic or solar power system any other form of renewable energy could be used without departing from the present invention. For example, the renewable energy source 50 could be any or more of a wind power system or a hydroelectric power system.

Likewise while the present invention has been found to be particularly useful for heating water using the electrical heating element, other appliances which are normally powered by the AC grid connection or via a renewable energy system with an inverter should not be excluded from the present invention. For example, such household appliances such as the refrigerator or air conditioner could also be powered using the controller 10, 120 in conjunction with a photovoltaic array 50 or other renewable energy source.

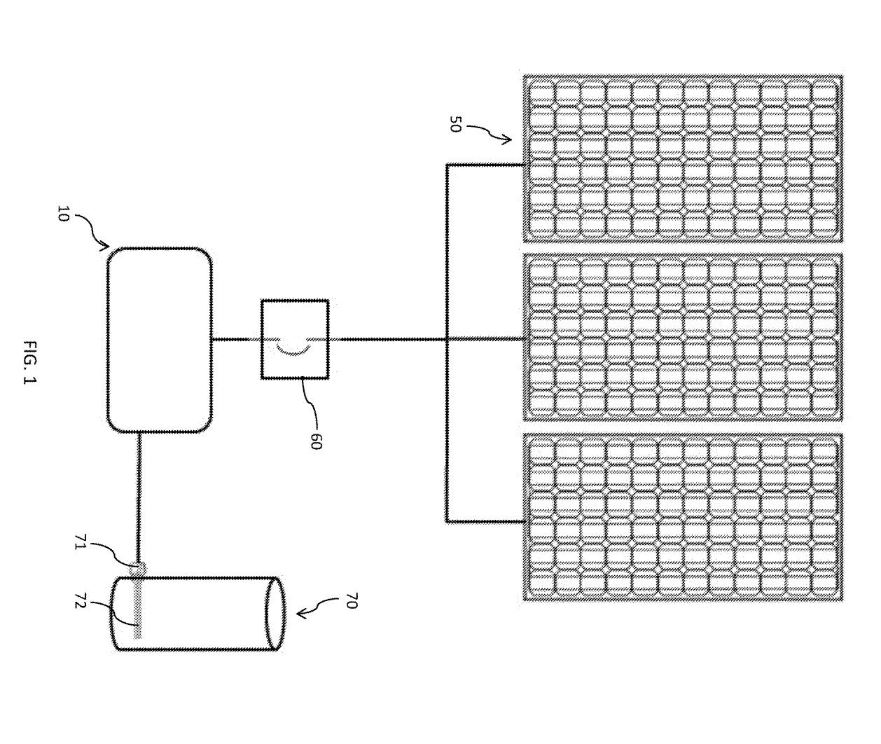

FIG. 1 illustrates an exemplary embodiment of the renewable energy hot water system 10 of the present invention. A photovoltaic array 50 with three photovoltaic panels provides a direct current source when exposed to sunlight. Each panel consists of a number cells formed by layers of a semi conducting material, usually silicon. When light shines on the cell it creates an electric field across the layers causing electricity to flow. The greater the intensity of incident light on panel, the greater the flow of electricity from the panel. While three panels are shown forming the array 50 the present invention is not limited to any particular number of panels. The photovoltaic array 50 gathers solar energy in the form of sunlight and converts it into direct current (DC) electricity. The number of panels and how they are interconnected determines the input voltage to the controller 10.

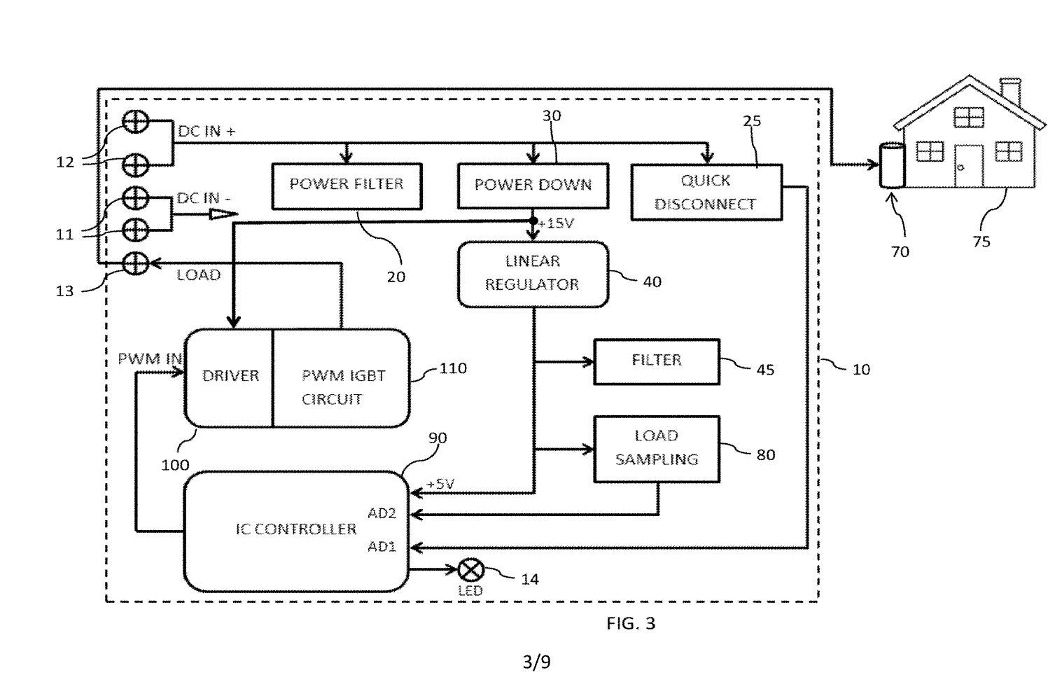

The controller 10 is isolated from the photovoltaic array 50 by the DC isolator or circuit breaker 60. DC PV isolator or circuit breaker 60 provides a method to stop current and voltage being supplied to the controller 10 when we would like to remove or service those items, or in the event of an emergency. The controller 10 will be described in more detail below in relation to FIGS. 3, 7 and 9. However in general the controller 10 takes the DC power from the photovoltaic array 50 and using a pulse width modulated signal to switch two insulated gate bipolar transistors (IGBT) connected in parallel at a high switching rate to produce a modified or converted pulsed DC signal to drive the heating element 72 and thermostat (not shown) via a connection 71 on the outside of the electric hot water system 70.

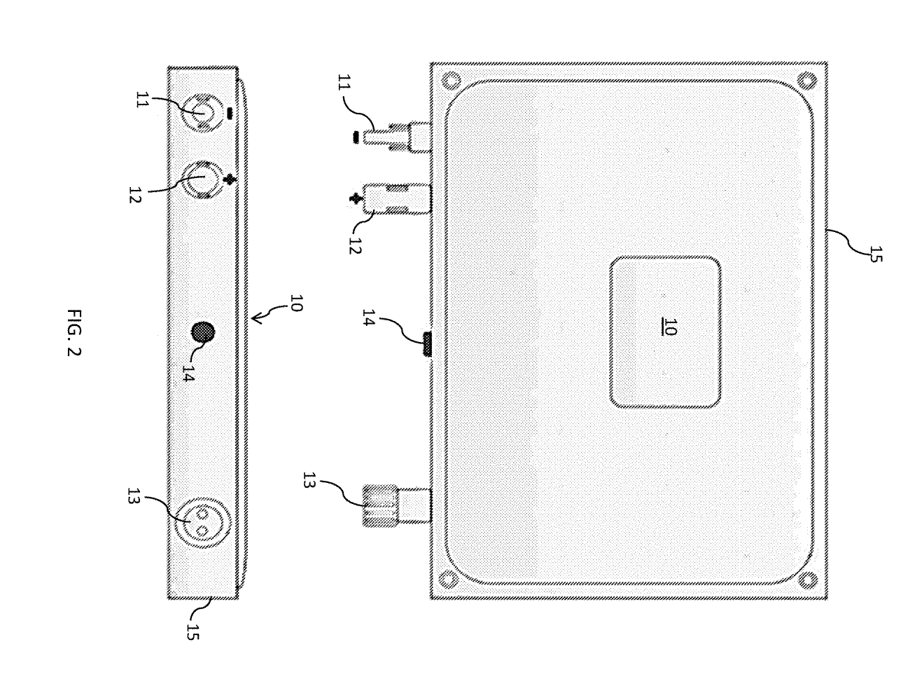

FIG. 2 shows a schematic of the controller 10 housed within a case 15. The case 15 is an IP65 waterproof design which allows the controller 10 to be installed indoors or outdoors. The IP65 is an ingress protection rating. The first number 6 identifies the category of protection in this case the 6 relates to the protection against contact and ingress of foreign bodies and provides complete protection against contact with live or moving parts inside the controller 10 and against the ingress of dust. The second numeral 5 provides that any water projected by a nozzle against the controller 10 from any direction shall have no harmful effect.

The controller 10 has a positive 12 and negative 11 input connectors from the photovoltaic array 50. The connectors 11, 12 are any suitable waterproof single contact connector. For example, an MC4 connector with an IP65 rating, the MC4 is a single-contact electrical connector with a 4 mm diameter contact pin commonly used for connecting solar panels 50. While these types of connector 11, 12 are designed to be easily connected they will require a special tool to disconnect them from the controller 10. The connection ensures that the connectors 11, 12 do not accidentally disconnect from the controller 10 when the cables are pulled.

An output connector 13 connects to the heating element 72 and is located on the same side of the case 15 as the DC input connectors 11, 12. The connector 13 is any suitable waterproof two pin connector. For example, a two pin M14 waterproof connector with an IP65 rating. Typically the connector 13 is a screw in-type two piece connector with a first part attached to the controller 10 and the other end attached to the output cable to the heating element 72. The connector 13 has butt type contacts which maintain a reliable electrical connection.

Also located on this side of the controller 10 is the power on LED 14 which is illuminated when the controller is operational and the output 13 is supplying power to the heating element 72.

FIG. 3 illustrates a block diagram showing the component circuits which operate the controller 10 to produce the modified or converted signal to drive the heating element 72 via a connection 71 located on the outside of the electric hot water system 70 for a residential property 75. The present invention which has been illustrated in use on a residential property 75 is equally applicable for any form of residential property and/or commercial property or office.

The controller 10 has DC in positive terminal 12 and DC in negative terminals 11 located adjacent one side of the controller 10. Just below on the same side is the load output terminal 13 which connects the output of the controller 10 to the load or electric hot water system 70. The DC voltage in from the solar array 50 will range from 60 to 160 V DC or 200 VOC and is largely dependent upon the number of photovoltaic panels in the solar array 50. The voltage open circuit (VOC) simply refers to the difference of electrical potential between two terminals of a device when disconnected from any circuit.

In this case the VOC is the difference between the DC in positive and negative terminals 12, 11 when disconnected from the controller 10.

A power filter circuit 20 is connected across the DC input terminals 11, 12 to filter and stabilise the input voltage. The power filter circuit also provides surge and reverse polarity connection protection for the controller 10. A power down circuit 30 is also connected to the DC input 11, 12 to drop the voltage from the photovoltaic array 50 to the required switching voltage of 15V. The power down circuit 30 uses a simple series voltage regulator to reduce the input voltage from the photovoltaic array 50 (60 to 160V DC) down to the required 15V DC.

The 15V DC is supplied to the linear regulator 40 and the insulated gate bipolar transistor (IGBT) driver circuit 100. The linear regulator 40 is a low-dropout DC to DC regulator which further reduces and stabilises the 15V input to a regulated 5V supply for the digital circuitry of the controller 10. The 5V regulated output is filtered by a simple bypass capacitor 45 which is used to bypass very small period spikes to earth with no influence on the other circuit components. The 15V DC is also supplied to the IGBT driver circuit 100 to provide the switching voltage for the IGBT's 110.

The regulated 5V acts as the positive power rail supply input for the microcontroller 90 and load sampling circuit 80. The load sampling circuit 80 is utilised to sense changes in the load supply and resets the microcontroller 90. The microcontroller 90 provides the pulse width modulated (PWM) signal to the IGBT driver circuit 100 to switch the IGBT's 110. A pulse width modulated signal is a technique where the width of digital pulses is adjusted to generate different average DC voltages. The microcontroller 90 has a built-in timer that is used to generate a PWM signal. The PWM output from the microcontroller 90 is a square wave that has a programmable pulse width (duty cycle).

The microcontroller 90 also provides an LED driver output which powers the LED 14 when the controller 10 is operational. An LED circuit is an electrical circuit used to power a light-emitting diode (LED) 14. The circuit must provide sufficient current to light the LED 14 at the required brightness, but must limit the current to prevent damaging the LED 14. The voltage drop across an LED 14 is approximately constant over a wide range of operating current; therefore, a small increase in applied voltage greatly increases the current. With an LED 14 with its cathode tied to ground, a high on the output pin of the microcontroller 90 will turn the LED 14 on.

With both the PWM signal from the microcontroller 90 and the IGBT switching voltage (15V DC) the IGBT driver circuit 100 is used to switch the IGBT's 110 at a very fast rate. This is accomplished by ensuring the proper gate voltage is supplied to the IGBT circuit 110 and also providing the correct gate current. In particular, the value of the gate current should be enough to charge and discharge in order to properly turn on or turn off the IGBT's 110. The switched PWM modulated signal of the IGBT's 110 provides the output to drive the heating element 72 of the electric hot water heater 70. This modulated output signal is produced purely from the DC supplied from the photovoltaic array 50. There is no modification required to the electric hot water system 70 as the original heating element 72 is used. The original heating element 72 and the thermostat are standard AC powered components used in all electric hot water systems 70.

In order to protect the thermostat (not shown) of the hot water system 70 which is located in series with the heating elements 72, 74 from any DC arcing associated with the pulsed DC supplied from the output of the controller 10 and photovoltaic array 50 a quick disconnect circuit 25 is provided. The quick disconnect circuit 25 has a detection circuit which is used to detect the measured value of a DC arc fault current in a conductor. The detection circuit measures the DC current using a small impedance in series with the circuit and by measuring the resultant voltage. If a resultant voltage is detected the quick disconnect circuit 25 is designed to quickly disconnect the controller 10 by shutting down the microcontroller 90 via the AD1 input and therefore avoiding any damage to the thermostat or heating elements.

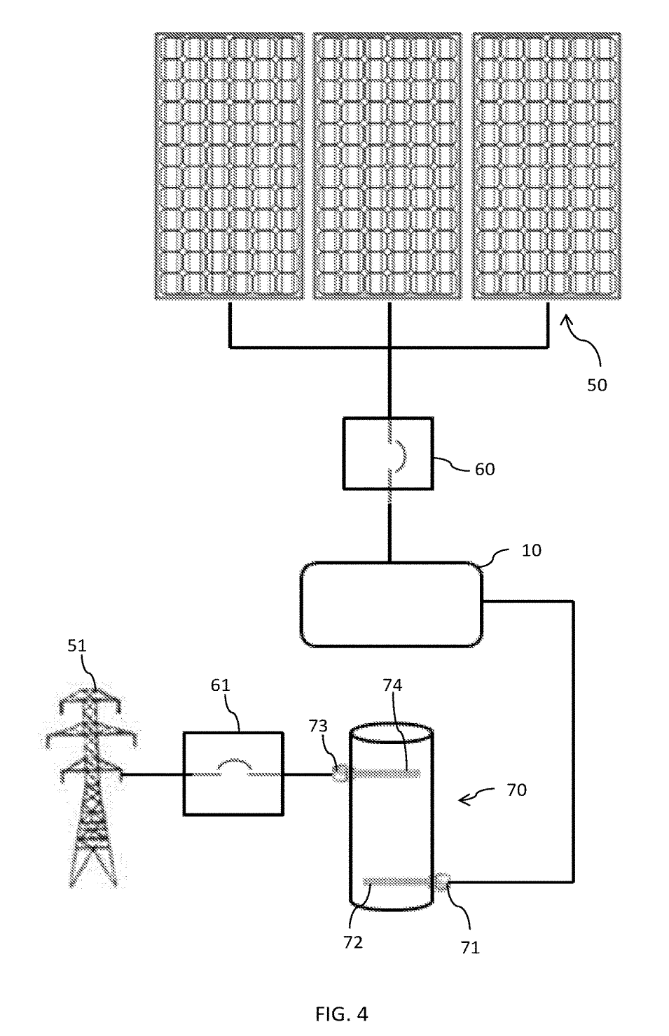

FIG. 4 illustrates a further embodiment of the present invention in which the electric hot water system 70 has a second heating element 74 and thermostat (not shown) connected to an AC grid connection 51 via connector 73. The remaining circuitry remains the same as that described above. The controller 10 is still provided with a DC input voltage from the photovoltaic array 50 and supplies a modified or pulsed DC voltage to the thermostat and heating element 72 via a connector 71 located on the outside of the electric hot water heater 70. In this embodiment the first element 72 is located near the bottom of the hot water system 70 and is the main heating element. The second element 74 is located closer to the top of the hot water system 70 and is typically used for “topping up” the water with heat, should it need it.

The AC grid connection 51 is typically provided by the electrical transmission lines and via an electrical isolator or circuit breaker 61. In remote locations the AC grid connection 51 could be replaced by an electric generator set. A generator is simply a device that converts mechanical energy to electrical energy for use in an external circuit. In this case the generator will supply an AC voltage to the second heating element 74.

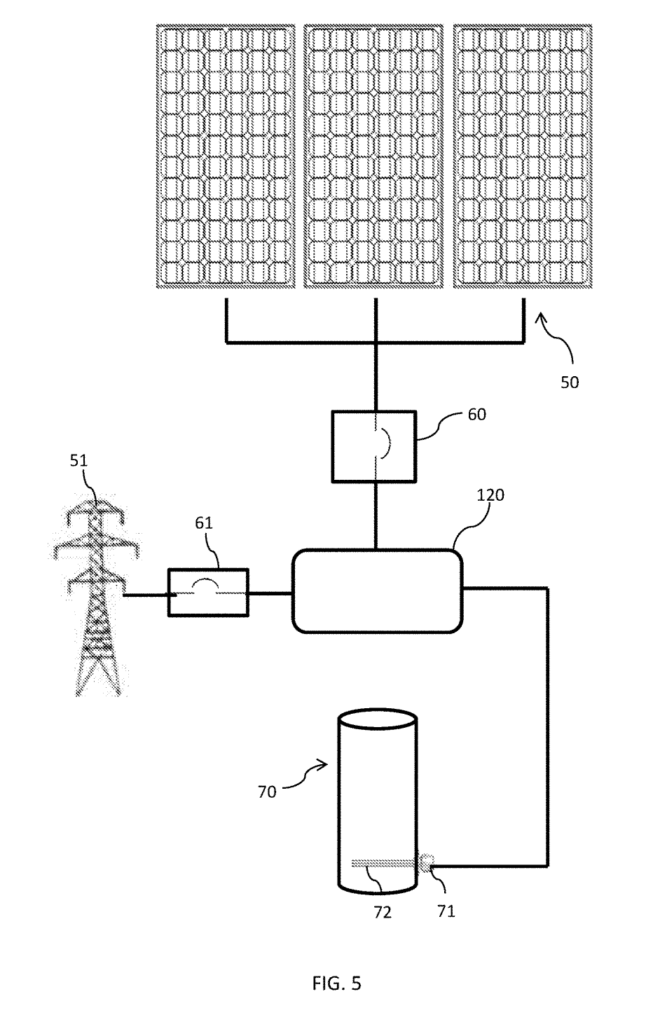

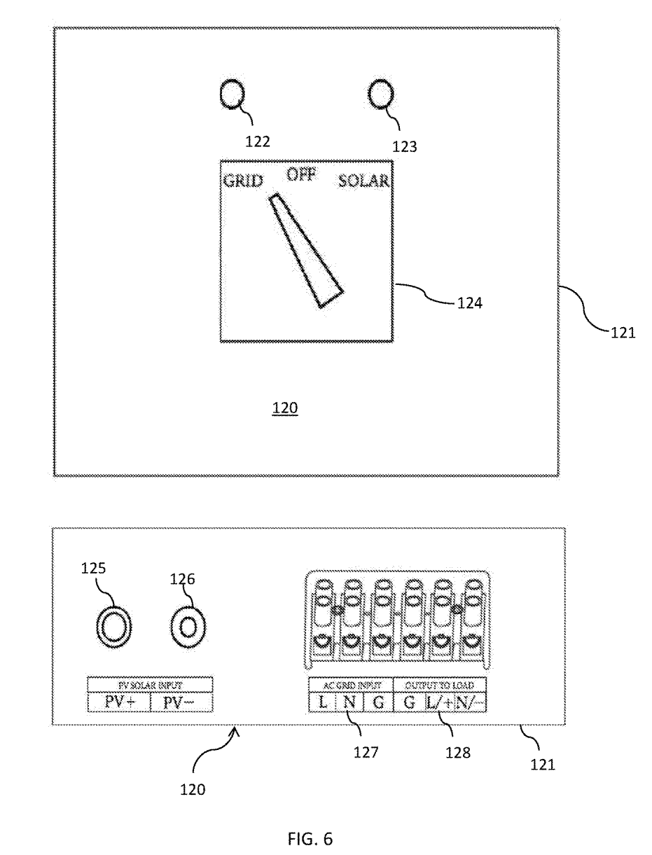

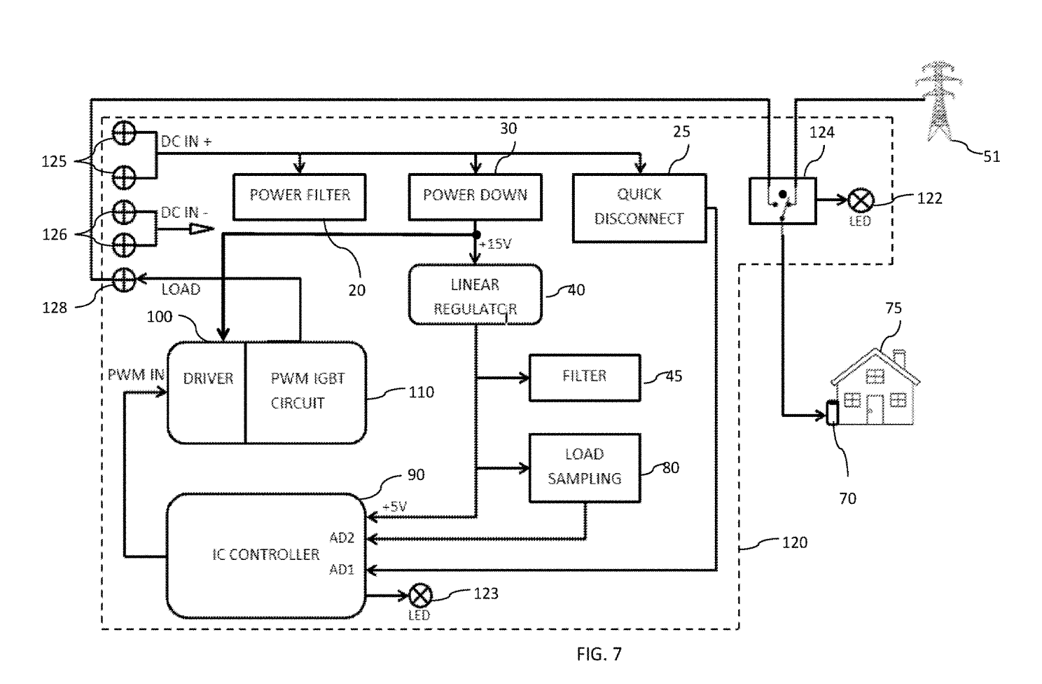

In a still further embodiment a shown in FIG. 5, a controller 120 is connected to both an AC input 51 via isolator or circuit breaker 61 and a DC input from a photovoltaic array 50 via DC isolator or circuit breaker 60. As will be described in further detail below in relation to FIGS. 6 and 7, the controller 120 is capable of switching between both inputs 50, 51 to provide power to a single thermostat and heating element 72 via connector 71 on the electric hot water system 70.

FIG. 6 shows the schematic of the controller 120 housed within a case 121. The controller 120 should be installed indoors or at least in a location that is dry, clean, cool and which has good ventilation. The controller 120 has a positive 125 and negative 126 input connectors from the photovoltaic array 50. The connectors 125, 126 are any suitable waterproof single contact connector. For example, the connector 125,126 is a similar MC4 electrical connector as described above in relation to the controller 10. The output connector 128 connects to the heating element 72 and is located on the same side of the case 121 as the DC input connectors 125, 126. The output connector 128 and the AC input connector 127 are formed as a terminal block with six separate blocks or terminals. As illustrated the screw terminals 127, 128 is a simple electrical connector where a wire is held by the tightening of a screw.

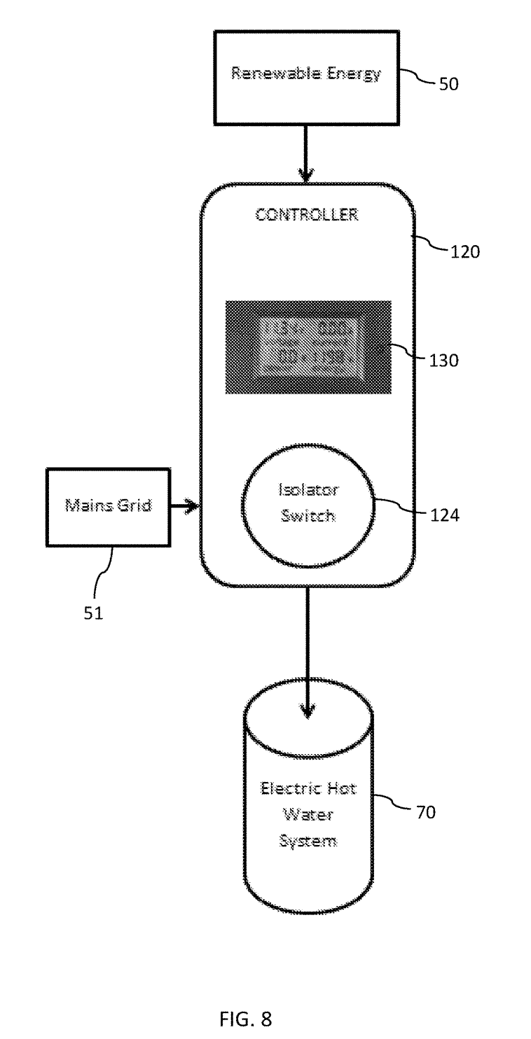

On the top side of the case 121 of the controller 120 are the DC power on LED 123, the AC power on LED 122 and the output selector switch 124. The output selector switch 124 is a rotary three position switch with a centre off position. In order for the AC grid to directly supply the heating element 72 the rotary switch is turned to the left and in this position the LED 122 is illuminated to indicate that the AC grid is being fed to the heating element 72. When the rotary switch is turned to the right the LED 123 is illuminated to indicate that the modified pulsed DC from the photovoltaic array via the controller 120 is being fed to the heating element 72. Any type of switching element 124 could be used as the output selector 124. For example and as will be described in relation to FIG. 8 below, an electronic isolator switch 124 may be used to replace the manual rotary switch 124.

FIG. 7 shows the same components as where described in relation to FIG. 3 and controller 10, with the exception of the added selector switch 124 and the AC grid connection 51 and LED indicator 122. All remaining components and circuitry remain unchanged and will therefore not be described further here. As illustrated the selector switch simply allows the user to select the option of powering the heater element 72 by an AC grid connection 51. This is particularly advantageous in poor weather conditions with prolonged periods without sunlight. The user will simply rotate the selector switch 124 to connect the grid connection 51 to the heater element 72 in the electric hot water system 70. As described above the AC LED 122 will be illuminated when the AC grid is powering the heater element 72. As previously described, in remote locations the AC grid connection 51 could be replaced by an electric generator set.

FIG. 8 illustrates a further embodiment of the present invention in which the controller 120 further consists of an LCD display 130 and an electronic selector switch 124. The LCD display 130 provides the user with a number of input and output parameter display values as well as in-built alarm display functions. By way of example only, the LCD display 130 in conjunction with the controller 120 can measure and monitor input and output voltage, current and power. The LCD display 130 is conveniently backlit to provide easy viewing in all light conditions. The LCD display 130 in conjunction with the controller 120 can set and monitor under and over voltage alarm conditions, under and over current alarm conditions, and reverse polarity and surge protection alarm warnings. The LCD display 130 also includes the ability to store values in an on-board memory and provide the stored values when requested.

As discussed briefly above the isolator switch 124 may be an electronic isolator switch which can be pre-programmed to switch from one output to another upon certain specified conditions. For example, should the renewable energy source 50 not be supplying sufficient power due to bad or inclement weather the selector switch 124 will automatically switch over to the AC grid connection 51 to supply power to the heater element 72 of the electric hot water system 70. Other conditions exist which may require the AC grid connection to provide the power source for the heater element 72 which have not been described above however should not be excluded from the present invention.

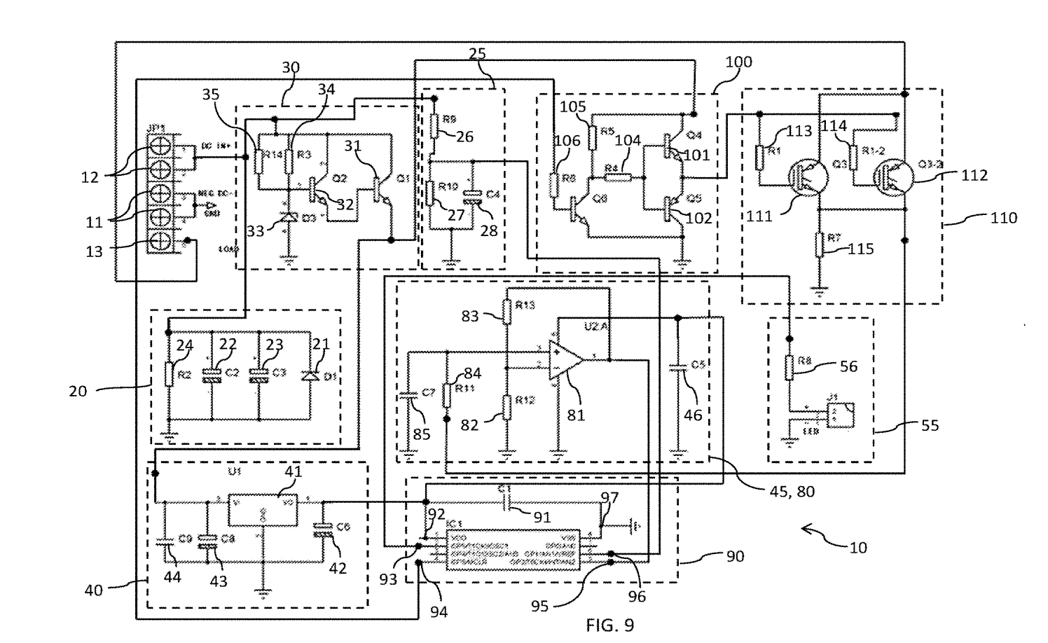

FIG. 9 shows a more detailed schematic drawing of the controller 10. The controller 10 has DC in positive and negative terminals 11, 12 located adjacent one side of the controller circuit board. Just below on the same side is the load output terminal 13 which connects the output of the controller 10 to the load or electric hot water system 70. The DC voltage in from the solar array 50 will range from 60 to 160 V DC or 200 VOC and is largely dependent upon the number of photovoltaic panels in the solar array 50. The power filter circuit 20 is connected across the DC input terminals 11, 12 to filter and stabilise the input voltage. The filter circuit 20 comprises varistor 24, filters 22, 23 and reverse polarity diode 21.

The varistor 24 is used to provide surge protection for the controller 10 and therefore as a control element to protect against excessive transient voltages. The varistor 24 will shunt the current created by the excessive voltage away from sensitive components when triggered. Also known as a voltage-dependent resistor (VDR), it has a nonlinear, non-ohmic current-voltage characteristic that is similar to that of a diode. In contrast to a diode however, it has the same characteristic for both directions of traversing current. At low voltage it has a high electrical resistance which decreases as the voltage is raised.

The reverse polarity diode 21 is simply designed to protect the controller 10 should the DC input 11, 12 be incorrectly connected. When the power supply polarity is correct the diode 21 is reverse biased and does not conduct. However if the polarity is reversed, the diode 21 conducts and limits the reverse voltage across the input 11, 12. Capacitors 22, 23 are filter capacitors which basically work on the principle of capacitive reactance. Capacitive reactance is how the impedance (or resistance) of a capacitor changes in regard to the frequency of the signal passing through it. Filter Capacitors 22, 23 filters out any unwanted AC signals or noise by acting as a low-pass filter, to pass DC signals and block AC.

Also connected across the DC input 11, 12 is the power down circuit 30. As the DC input voltage is variable from 60 to 160V DC in order to provide the 15V switching voltage for the IGBT circuit 110 the voltage must be dropped from the photovoltaic array 50. The power down circuit 30 uses a simple series voltage regulator to reduce the input voltage from the photovoltaic array 50 (60 to 160V DC) down to the required 15V DC. The series voltage regulator consists of transistors 31, 32 and zener diode 33 used as a low ripple regulated voltage stabiliser or a voltage regulator, designed to reduce the voltage by a set level and stabilise the voltage at an optimum level.

The transistors 31 and 32 are formed as a Darlington pair. The Darlington pair is a compound structure consisting of two bipolar transistors 31, 32 connected in such a way that the current amplified by the first transistor 32 is amplified further by the second transistor 31. This configuration gives a much higher current gain than each transistor 31, 32 taken separately. Resistors 34 and 35 provide the base current for transistor 32 and also keep the zener diode 33 in the active region. Resistors 34, 35 also limit the current to the power down circuit 30 and zener diode 33. Because of the low impedance of the diode 33 when operated in the reverse breakdown voltage the resistors 34, 35 are used to limit current through the circuit 30.

In the power down circuit 30 the zener diode 33 is used as a voltage reference to regulate the voltage across the circuit. When connected in parallel with a variable voltage source so that it is reverse biased the zener diode 33 conducts when the voltage reaches the diodes reverse breakdown voltage. From that point on, the relatively low impedance of the diode 33 keeps the voltage across the diode 33 at that value. In this case the input voltage (60-160V DC) from the PV array is regulated down to a stable output voltage of 15V. The breakdown voltage of the diode 33 is stable over a wide current range and holds the output voltage relatively constant even though the input voltage may fluctuate over a fairly wide range.

The 15V DC provided by the series linear regulator or power down circuit 30 is supplied to the linear regulator circuit 40 and the insulated gate bipolar transistor (IGBT) driver circuit 100. The linear regulator circuit 40 is a low-dropout DC to DC regulator which further reduces and stabilises the 15V input to a regulated 5V supply for the digital circuitry of the controller 10. The low-dropout or LDO regulator 41 is a DC linear voltage regulator that does not store energy or repetitively switch its transistor on and off. The LDO regulator 41 merely drops excess input voltage across a pass transistor, operated in the active region, to create a low-noise and regulated output voltage of 5V. With no switching or energy storage, an LDO regulator 41 produces very little noise, requires no inductor, and provides a high-accuracy output voltage. The regulated 5V acts as the positive power rail supply input for the microcontroller 90 and load sampling circuit 80.

The linear regulator circuit 40 also consists of capacitor 42 which is the filter capacitor employed in the circuit 40 to steady the slow alterations in the output voltage (5V). Capacitor 43 which is the filter capacitor employed to steady the slow changes in the voltage applied at the input (15V) of the circuit 40. Finally capacitor 44 is a bypass capacitor and is employed to bypass extremely tiny duration spikes to the ground with no distress the other components of the circuit 40.

The 5V regulated output from the linear regulator circuit 40 is filtered by a simple bypass capacitor circuit 45 which is formed by the bypass capacitor 46 which is designed to bypass very small period spikes to earth with no influence on the other circuit components.

The regulated 5V acts as the positive power rail supply input for the microcontroller 90 and load sampling circuit 80. The microcontroller unit (MCU) 90 is a small computer on a single integrated circuit containing a processor core, memory, and programmable input/output peripherals. The +5V is supplied to pin 1, the VDD input 92 of the microcontroller 90. A ground is provided on pin 8, the VSS input 97 and a decoupling capacitor 91 ensures that VDD 92 and VSS 97 are at the same signal voltage (gets rid of noise). Pin 2 of the microcontroller 90 is used as Led driver output 93. The microcontroller 90 with the correct current and voltage drives an LED 14 directly from the output pin 93 on the microcontroller 90.

With the +5V regulated input 92 the microcontroller 90 provides the pulse width modulated (PWM) signal to the IGBT driver circuit 100 to switch the IGBT's 110. The MCLR Output 94 which is pin 4, provides a pulse width modulated signal which is used to drive the IGBT's 110. Pulse Width Modulation (PWM) is a technique where the width of digital pulses is adjusted to generate different average DC voltages. The microcontroller 90 has a built-in timer that is used to generate a PWM signal. The PWM output 94 from the microcontroller 90 is a square wave that has a programmable pulse width (duty cycle). The microcontroller 90 uses its clock source and a built-in timer mechanism to produce the PWM signal. By controlling the internal timer to count up and then set back to 0 at a particular count, the timer will count up and then set back to 0 over and over again. This sets your period. You now have the option of controlling a pulse, turning a pulse on at a specific count in the timer while it goes up. When the counter goes back to 0, then you turn off the pulse.

With both the PWM signal from the microcontroller 90 and the IGBT switching voltage (15V DC) the IGBT driver circuit 100 is used to switch the IGBT's 111, 112 at a very fast rate. This is accomplished by ensuring the proper gate voltage is supplied to the IGBT's 111, 112 and also providing the correct gate current. In particular, the value of the gate current should be enough to charge and discharge in order to properly turn on or turn off the IGBT's 111, 112.

The IGBT Driver Circuit 100 consists of the driver transistor 103 and emitter follower transistors 101, 102 connected as a simple push pull output stage. The driver transistor 103 is a common emitter amplifier, inverting the signal with gain from base to collector. Resistors 104, 105, 106 are simple voltage drop resistors to provide the correct biasing for the transistors 101, 102, 103. Transistors 101, 102 form a circuit consisting of two emitter-follower transistors. The top emitter follower 101 is an NPN transistor and the lower emitter-follower 102 is a PNP transistor. This is called a push pull output stage. The transistors 101, 102 are emitter followers driving the same load, the operation is simple; 101 conducts on positive swings; 102 conducts on negative swings. Therefore transistors 101, 102 amplify alternate halves (positive and negative, respectively) of the PWM square wave signal supplied from the driver transistor 103. The parallel connection of the bases of transistors 101, 102 allows phase splitting. The output to the gates of the IGBT's 111, 112 is the emitter load for transistors 101, 102.

The PWM output pulses or square pulses are provided to drive push-pull converter 101, 102 and provides isolation for the gate driver circuit of the IGBT's 111, 112. The output of the push pull converter provides the positive 15V switching voltage for the IGBT's 111, 112. The driver transistor 103 and the push pull converter 101, 102 provide the ideal switching platform for the IGBT's 111, 112 by providing them with minimum stray inductance issues and quick discharge of the internal capacitance of the IGBT's 111, 112.

The IGBT circuit 110 consists of two 600V 40 A field stop IGBT's 111, 112 with built in anti-parallel diodes. The insulated gate bipolar transistors (IGBT) 111, 112 are a semiconductor device used as an electronic switch that combines high efficiency and fast switching. The IGBT's 111, 112 are connected in parallel and have an isolated gate FET as the control input of a BJT. The microcontroller 90 is designed to switch in a parallel mode (single ended mode), meaning the output PWM1 (pin 4) 94 will switch IGBT's 111 and 112 together and not alternately.

The IGBT's 111, 112 have a metal-oxide semiconductor (MOS) gate input structure, which has a simple gate control circuit design and is capable of fast switching up to 100 k Hz. Additionally, because the IGBT 111, 112 outputs has a bipolar transistor structure, its current conduction capability is superior to a bipolar power transistor. The IGBT 111, 112 can be made to conduct when appropriate voltage (generally +15V) is introduced to the gate of IGBT 111, 112, and the current is cut off when the voltage between the gate and emitter is below the threshold voltage, generally, less than 0V.

The series resistance 113, 114 is connected to the gate of the IGBT 111, 112 and is a parameter that has a significant effect on switching waveform. The switching behaviour of the IGBT 111, 112 is controlled by the gate capacitance recharge. This gate capacitance recharge may be controlled by the gate resistor 112, 114. By using a typical positive control voltage (VG(on)) of +15V the IGBT 111, 112 is turned-on and turned-off at a negative output voltage (VG(off)) of typically −5, −8, or −15V. The dynamic IGBT 111, 112 performance can be adjusted by the value of the gate resistor 112, 114. As the input capacitance of an IGBT 111, 112, which varies during switching time, has to be charged and discharged, the gate resistor 113, 114 will dictate what time is needed to do this by limiting the magnitude of the gate current (IG) pulses during turn-on and turn-off.

It is desirable to minimise the duration of the turn on and off phases as during these times the devices 111, 112 are not fully switched and are in a high dissipation mode, i.e. while there is a significant voltage across their outputs there is also significant current flow. With higher drain/collector currents, particularly when switching inductive loads, there is a conflict in the requirement to switch the parts as quickly as possible but to not introduce unacceptably high levels of induced voltage spiking that could impede the switch on or off and in extreme conditions generate spikes that could irreparably damage the IGBTS 111, 112, particularly their gate insulations. Thus, the series gate resistors 113, 114 prevent any transients trying to make its way into the IGBT 111, 112 thus ensuring the operations to be entirely safe and efficient.

The switched PWM modulated signal of the IGBT circuit 110 provides via the load output terminal 13, the power to drive the heating element 72 and thermostat of the electric hot water heater 70. This modulated pulsed DC output signal is produced purely from the DC supplied from the photovoltaic array 50. There is no modification required to the electric hot water system 70 as the original heating element 72 and thermostat is used.

The microcontroller 90 also provides an LED driver output 93 which powers the LED 14 through the LED driver circuit 55 when the controller 10 is operational. An LED circuit is an electrical circuit used to power a light-emitting diode (LED) 14. The circuit must provide sufficient current to light the LED 14 at the required brightness, but must limit the current to prevent damaging the LED 14. The voltage drop across an LED 14 is approximately constant over a wide range of operating current; therefore, a small increase in applied voltage greatly increases the current. With an LED 14 with its cathode tied to ground, a high on the output pin 93 of the microcontroller 90 will turn the LED 14 on.

The LED driver circuit 55 also consists of the current limiting resistor 56 and a two pin connector J1. Resistor 56 is connected in series with the LED 14 and is a current limiting resistor, sometimes called the ballast resistor. Limiting current into an LED 14 is very important. The current limiting resistor 56 is used in series with the LED 14 to keep the current at a specific level called the characteristic (or recommended) forward current. This will ensure the forward voltage (usually between 1.5-4V for LEDs) will be reached to turn ‘on’ the LED 14, but as you exceed the characteristic forward voltage, the LED's resistance quickly drops off and the current limiting resistor 56 will ensure that the LED 14 will not burn out.

A load sampling circuit 80 is required to ensure that the output of the switched PWM modulated signal of the IGBT circuit 110 providing power to drive the heating element 72 is switched on and off in accordance with the set-point of the thermostat of the electric hot water heater 70. The load sampling circuit 80 is utilised to sense changes in the load supply and resets the microcontroller 90. The AD2 pin 5 input 95 of the microcontroller 90 is an analog input which receives a signal from the load sampling circuit 80 to reset the program.

The load (heating element 72) is sampled from the emitter of the IGBT's 111, 112 via the resistance network consisting of resistor 115 and through series resistor 84 to the inverting input of the opamp 81. The closed loop non-inverting amplifier 81 is designed so that the output voltage changes in the same direction as the input voltage. Negative feedback is used, by applying a portion of the output voltage to the inverting input of the opamp 81. The closed loop feedback greatly reduces the gain of the circuit. When negative feedback is used, the circuit's overall gain and response becomes determined mostly by the feedback network, rather than by the op-amp characteristics. Resistors 82, 83 form a voltage divider network for the opamp 81 feedback loop. The voltage divider network 82, 83 in the negative feedback wiring is designed so that only a fraction of the output voltage is fed back to the inverting input instead of the full amount. Therefore, the output voltage will be a multiple of the input voltage. Capacitor 85 is a shunt capacitor which provides a path for high frequency signals to ground, preventing them from getting into the opamp 81.

In order to protect the thermostat and heating elements from any DC arcing from the pulsed DC from the controller and the photovoltaic array 50, a quick disconnect circuit 25 is provided. The quick disconnect circuit 25 has a detection circuit which is used to detect the measured value of a DC arc fault current in a conductor. The detection circuit comprises series resistors 26, 27 forming a voltage divider network designed for reducing the measured voltage (DC IN) to a voltage of between 0 to 5V for the input AD1 96 on the microcontroller 90. The detection circuit measures the DC current using a small impedance in series with the circuit and by measuring the resultant voltage. If a resultant voltage is detected the quick disconnect circuit 25 is designed to quickly disconnect the controller 10 by shutting down the microcontroller 90 via the AD1 input 96 and therefore avoiding any damage to the thermostat and heating elements. The capacitor 28 is used to help reduce any high-frequency noise.

While the above circuitry has been described in relation to specific processes or protection devices it should be understood by a person skilled in the art that other similar circuits and devices could easily be utilised to perform the same or similar processes or protection devices. Furthermore, the present invention has been described in relation to a solar hot water controller 10, 120 it should be understood that the present invention can also be utilised with any other renewable energy source.

While the present invention has been mainly described in relation to the heating element 72 in an electric hot water system 70, other uses could be envisaged. For example, the present invention could also be used to heat the water for heating hot tubs and preheating gas hot water systems by adding a small electric hot water tank. Likewise as previously discussed other appliances could suitably be powered by the controllers 10, 120. For example, such appliances as the refrigerator or air conditioner could also be powered by the controller 10, 120 connected to a photovoltaic array 50 or any other renewable energy source.

The present invention provides a modulated output signal produced purely from the DC supplied from the photovoltaic array 50. There is no modification required to the electric hot water system 70 as the original heating element 72 is used. The PWM switching of the IGBT's 111, 112 provide an electronic switch that combines high efficiency and fast switching. The efficiency of the present system exceeds 97% far greater than any other comparable renewable energy hot water heater.

### Advantages

It will be apparent that the present invention relates generally to a renewable energy water heating system and method for residential and commercial applications. The present invention has been designed to fix a problem in the market which exists due to the present systems not providing a purely DC driven high efficiency hot water system.

The present invention provides a hot water controller which is inexpensive and provides a product with multiple applications such as an off the grid controller for both residential and commercial applications. The hot water controller is designed to be used with all forms of renewable energy such as solar, wind and hydro. The present invention does not require any modification to the present electric hot water tank as the same heating element is utilised. The present invention also provides the alternative connection of a mains grid or back-up generator for providing a boost if there is prolonged inclement or poor weather or simply if you require a boost to the current hot water requirements.

The present invention does not require any changes to the plumbing of the hot water system therefore the renewable energy hot water controller can simply be installed by any licensed electrician using two or three standard solar panels and mains grid connections.

The efficiency of the renewable energy hot water controller is around 30% more efficient than stored renewable energy. This is mainly due to the around 30% loss of energy in charging batteries. The renewable energy hot water controller is also up to 30% more efficient than traditional solar hot water systems due to the high efficiency on cloudy days and cold weather. The present invention provides a controller with a high 97% efficiency making it one of most efficient year round ways of producing hot water using renewable energy.

The controller uses a PWM switched IGBT circuit to control the amount of power delivered to a load without incurring the losses that would result from linear power delivery by resistive means. The modulated or pulsed DC signal produced provides an efficient fast switching solution for controlling the heating element in any electric hot water requirement.

### Variations

It will be realised that the foregoing has been given by way of illustrative example only and that all other modifications and variations as would be apparent to persons skilled in the art are deemed to fall within the broad scope and ambit of the invention as herein set forth.

Various substantially and specifically practical and useful exemplary embodiments of the claimed subject matter, are described herein, textually and/or graphically, including the best mode, if any, known to the inventors for carrying out the claimed subject matter. Variations (e.g., modifications and/or enhancements) of one or more embodiments described herein might become apparent to those of ordinary skill in the art upon reading this application. The inventors expect skilled artisans to employ such variations as appropriate, and the inventors intend for the claimed subject matter to be practiced other than as specifically described herein. Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:

(a) there is no requirement for the inclusion of any particular described or illustrated characteristic, function, activity, or element, any particular sequence of activities, or any particular interrelationship of elements;

(b) no characteristic, function, activity, or element is “essential”;

(c) any elements can be integrated, segregated, and/or duplicated;

(d) any activity can be repeated, any activity can be performed by multiple entities, and/or any activity can be performed in multiple jurisdictions; and

(e) any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

1. A renewable energy hot water heating system comprising:
a renewable energy source providing a DC electric current;
a controller connected to the renewable energy source;
an electric water heater connected to the controller, the water heater comprising a water storage tank and at least one AC heating element and at least one AC thermostat for heating water in the tank responsive to an electric current supplied thereto; and
wherein the controller comprises a pair of parallel single-ended pulse width modulated insulated-gate bipolar transistors which modulate and switch the DC electric current from the renewable energy source to produce a pulsed DC output to the at least one AC heating element and at least one AC thermostat to heat the water.

2. A renewable energy hot water heating system as claimed in claim 1, wherein the renewable energy source is any one or more of solar, wind or hydro energy.

3. A renewable energy hot water heating system as claimed in claim 2, wherein the controller further comprises a microcontroller, the microcontroller produces a pulse width modulated signal to switch the DC electric current from the renewable energy source to switch the pair of insulated-gate bipolar transistors to produce the pulsed DC output to provide the electric current to the at least one AC heating element and thermostat.

4. (canceled)

5. (canceled)

6. A renewable energy hot water heating system as claimed in claim 3, wherein the controller further comprises an arc fault detection circuit adapted to suppress any arching within the AC thermostat caused by the pulsed DC output from the controller, the arc fault detection circuit is designed to quickly disconnect an output of the pair of insulated-gate bipolar transistors by shutting down the microcontroller.

7. A renewable energy hot water heating system as claimed in claim 4, wherein the controller further comprises a microcontroller low drop out linear regulator.

8. A renewable energy hot water heating system as claimed in claim 5, wherein the hot water heating system has a 97% heating efficiency which is achieved by the controller through the low energy consumption of the arch suppression, pulse width modulation and insulated-gate bipolar transistor switching.

9. (canceled)

10. A renewable energy hot water heating system as claimed in claim 6, wherein the AC thermostat is located in series with the at least one AC heating element, and wherein the pulsed DC output from the controller is supplied to the AC heating element via the AC thermostat.

11. A renewable energy hot water heating system as claimed in claim 7, wherein the electric water heater comprises two AC heating elements and two AC thermostats for heating water in the tank, one AC element and thermostat is provided with the pulsed DC electric output from the controller and a second AC element and thermostat is provided with an AC grid connection to provide the electric current to the second AC heating element and thermostat.

12. (canceled)

13. A renewable energy hot water heating system comprising:
a renewable energy source providing a DC electric current;
an AC electric current supplied by a grid connection;
a controller connected to the renewable energy source and the grid connected AC, the controller comprises a pair of parallel single-ended pulse width modulated insulated-gate bipolar transistors which modulate and switch the DC electric current from the renewable energy source to produce a pulsed DC converted output;
an isolator switch for selecting either the renewable energy source or the AC grid connection;
an electric water heater connected to the controller, the water heater comprising a water storage tank and at least one AC heating element and at least one AC thermostat for heating water in the tank responsive to an electric current supplied thereto; and
wherein when the isolator switch is connected to the renewable energy source the controller provides the pulsed DC electric current to the at least one AC heating element and at least one AC thermostat.

14. A renewable energy hot water heating system as claimed in claim 13, wherein the renewable energy source is any one or more of solar, wind or hydro energy.

15.-27. (canceled)

28. A renewable energy hot water heating system as claimed in claim 14, wherein the controller further comprises a microcontroller, the microcontroller produces a pulse width modulated signal to switch the DC electric current from the renewable energy source to switch the pair of insulated-gate bipolar transistors to produce the pulsed DC output to provide the electric current to the at least one AC heating element and thermostat.

29. A renewable energy hot water heating system as claimed in claim 28, wherein the controller further comprises an arc fault detection circuit adapted to suppress any arching within the AC thermostat caused by the pulsed DC output from the controller, the arc fault detection circuit is designed to quickly disconnect an output of the pair of insulated-gate bipolar transistors by shutting down the microcontroller.

30. A renewable energy hot water heating system as claimed in claim 29, wherein the controller further comprises a microcontroller low drop out linear regulator.

31. A renewable energy hot water heating system as claimed in claim 30, wherein the hot water heating system has a 97% heating efficiency which is achieved by the controller through the low energy consumption of the arch suppression, pulse width modulation and insulated-gate bipolar transistor switching.

32. A hot water heating system comprising:
a storage tank having an inlet fluidly connectable to a water supply, an outlet fluidly connectable to at least at least one valve, wherein when the valve is opened, water from the water supply displaces water through the storage tank and out the outlet;
a first AC heating element connectable to a power source that provides AC electricity;
a first AC thermostat interconnected to the first AC heating element, wherein the thermostat controls operation of the first AC heating element based at least in part on a temperature of water in the storage tank;
a controller connected to a power source that provides DC power, the controller comprises a pair of parallel single-ended pulse width modulated insulated-gate bipolar transistors which modulate and switch the DC electric current from the DC power source to produce a pulsed DC converted output;
a second AC heating element connectable to the pulsed DC converted output of the controller; and
a second AC thermostat interconnected to the second AC heating element, wherein the thermostat controls operation of the second AC heating element based at least in part on a temperature of water in the storage tank.

33. A hot water heating system as claimed in claim 32, wherein the DC power source is provided by any one or more of:
(a) a solar power system;
(b) a wind power system;
(c) a hydroelectric power system; or
(d) a battery.

34. A hot water heating system as claimed in claim 33, wherein the AC power source is provided by any one or more of:
(a) a grid connected transmission system; or
(b) a generator.

35. A hot water heating system as claimed in claim 34, wherein the controller further comprises a microcontroller, the microcontroller produces a pulse width modulated signal to switch the DC electric current from the DC power source to switch the pair of insulated-gate bipolar transistors to produce the pulsed DC output to provide the electric current to the second AC heating element and thermostat.

36. A hot water heating system as claimed in claim 35, wherein the controller further comprises a microcontroller low drop out linear regulator and an arc fault detection circuit adapted to suppress any arching within the AC thermostat caused by the pulsed DC output from the controller, the arc fault detection circuit is designed to quickly disconnect an output of the pair of insulated-gate bipolar transistors by shutting down the microcontroller.

37. A hot water heating system as claimed in claim 19, wherein when the hot water heating system is only powered by the DC power source the hot water heating system has a 97% heating efficiency which is achieved by the controller through the low energy consumption of the arch suppression, pulse width modulation and insulated-gate bipolar transistor switching.
